(19) United States
(12) Patent Application Publication
(10) Pub. No.: US 2005/0242120 A1
(43) Pub. Date: Nov. 3, 2005

(54) Automatic cup type beverage vending machine

(75) Inventors: Takeshi Sato, Isesaki-shi (JP); Takahiro Toriumi, Isesaki-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Sanden Corporation, Isesaki-shi (JP)

(21) Appl. No.: 11/108,896

(22) Filed: Apr. 19, 2005

(30) Foreign Application Priority Data
Apr. 20, 2004 (JP) 2004/124381

(51) Int. Cl. B67D 5/62

(52) U.S. Cl. 222/146.6

(57) ABSTRACT

An automatic cup type beverage vending machine capable of mixing small pieces of ice and a liquid material finely and uniformly through the entire beverage. A liquid material (sugar and cream diluted with diluent hot water and a coffee solution) and small pieces of ice are agitated by an agitation mechanism and the cup is shaken by a shaking mechanism. Mixing of the liquid material and small pieces of ice can be performed not only by agitation of the liquid material and small pieces of ice but also by shaking of the cup. Therefore, the liquid material and small pieces of ice can be mixed uniformly and finely with each other in the entire beverage and any parts of them are not left in an insufficiently mixed state. The machine can therefore prepare a beverage which is not inferior in terms of touch to the tongue and palate and appearance to one prepared by mixing a liquid material and crushed ice while crushing ice by a mixer as in a beverage store.

### BACKGROUND OF THE INVENTION

(i) Field of the Invention

The present invention relates to an automatic cup type beverage vending machine which sells a beverage prepared by mixing a liquid material, for example, of a coffee taste or a fruit taste with small pieces of ice.

(ii) Description of the Related Art

An automatic cup type beverage vending machine is generally known which sells a cold beverage by feeding a liquid material into a cup in which the beverage is to be contained, and throwing ice in solid form made by an ice maker into the cup. In this case, the ice is thrown into the cup for the purpose of cooling the beverage and is not usually drunk together with the beverage. A vending machine is known in which ice crushed into small pieces is mixed with a liquid material in a cup to prepare a beverage such that ice can be drunk together with the liquid (see, for example, Japanese Patent Publication No. 2003-303371).

In beverage stores in which various beverages are sold, a beverage in which ice is finely mixed in a liquid is prepared in such a manner that a liquid material is mixed with crushed ice in a mixer while ice is being crushed by the mixer. On the other hand, in a machine in which small pieces of ice are thrown into a cup and mixed with a liquid material as described above, the ice cannot be finely mixed with the liquid. The beverage prepared in this way is inferior to commodities sold in beverage stores in terms of touch to the tongue and palate and appearance. If a mechanism for agitating a beverage by inserting an agitating member in a cup to rotate it is used, it is possible to finely mix small pieces of ice and a liquid material. However, a beverage in which small pieces of ice and a liquid material are mixed is not in a complete liquid form but in a semisolid form. Therefore, parts of small pieces of ice and a liquid material are left in an insufficiently mixed state if the agitating member is rotated only at a predetermined position, resulting in failure to uniformly mix the pieces of ice and the liquid material through the entire beverage.

### SUMMARY OF THE INVENTION

An object of the present invention is to provide an automatic cup type beverage vending machine capable of mixing small pieces of ice and a liquid material finely and uniformly through the entire beverage.

To achieve the above-described object, according to the present invention, there is provided an automatic cup type beverage vending machine in which a liquid material and small pieces of ice are agitated in a cup for containing a beverage to prepare a beverage in which the liquid material and small pieces of ice are mixed with each other, the vending machine having material supply means of supplying a liquid material or a powder material for forming a liquid material into the cup, small ice piece supply means of supplying small pieces of ice into the cup, agitation means of agitating the liquid material and small pieces of ice in the cup, and shaking means of shaking the cup in a predetermined direction at the time of preparation of the beverage.

The liquid material and small pieces of ice in the cup are agitated by the agitation means and the cup is shaken by the shaking means. Mixing of the liquid material and small pieces of ice can be performed not only by agitation of the liquid material and small pieces of ice but also by shaking of the cup. Therefore, the liquid material and small pieces of ice can be mixed uniformly and finely with each other in the entire beverage and any parts of them are not left in an insufficiently mixed state. Thus, a beverage can be prepared which is not inferior in terms of touch to the tongue and palate and appearance to one prepared by mixing a liquid material and crushed ice while crushing ice by a mixer as in a beverage store for example.

### BRIEF DESCRIPTION OF THE DRAWINGS

FIG. 1 is a front view of an automatic cup type beverage vending machine representing an embodiment of the present invention;

FIG. 2 is a diagram schematically showing the construction of the automatic cup type beverage vending machine;

FIG. 3 is a block diagram of a control system;

FIG. 4 is a side view of a shaking mechanism;

FIG. 5 is a plan view of the shaking mechanism;

FIG. 6 is a diagram for explaining the operation, showing a beverage preparation process;

FIG. 7 is a diagram for explaining the operation, showing the beverage preparation process;

FIG. 8 is a diagram for explaining the operation, showing the beverage preparation process;

FIG. 9 is a diagram for explaining the operation, showing the beverage preparation process;

FIG. 10 is a time chart showing the operation of the control unit;

FIG. 11 is a perspective view of a cup containing a frappe beverage;

FIG. 12 is a time chart showing the operation of the control unit in another embodiment;

FIG. 13 is a time chart showing the operation of the control unit in still another embodiment;

FIG. 14 is a time chart showing the operation of the control unit in still another embodiment;

FIG. 15 is a time chart showing the operation of the control unit in still another embodiment;

FIG. 16 is a time chart showing the operation of the control unit in still another embodiment; and

FIG. 17 is a time chart showing the operation of the control unit in still another embodiment.

### DESCRIPTION OF THE PREFERRED EMBODIMENTS

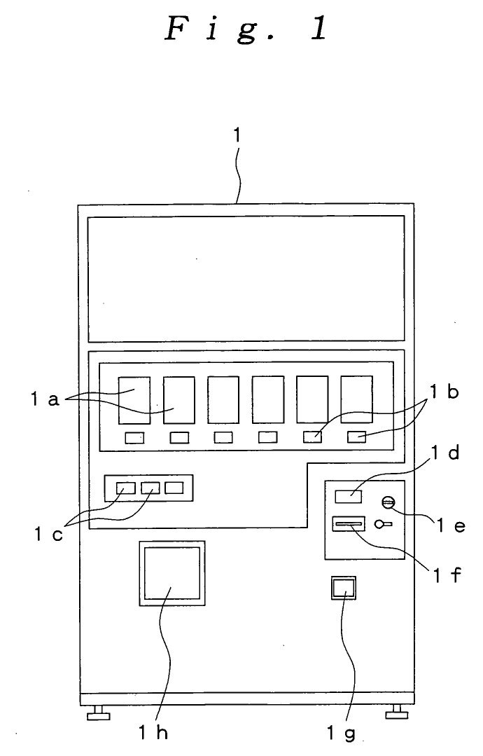

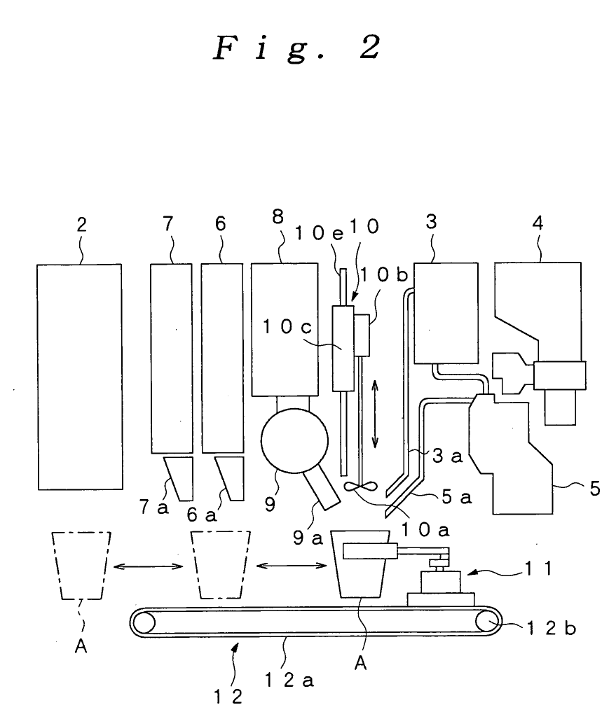

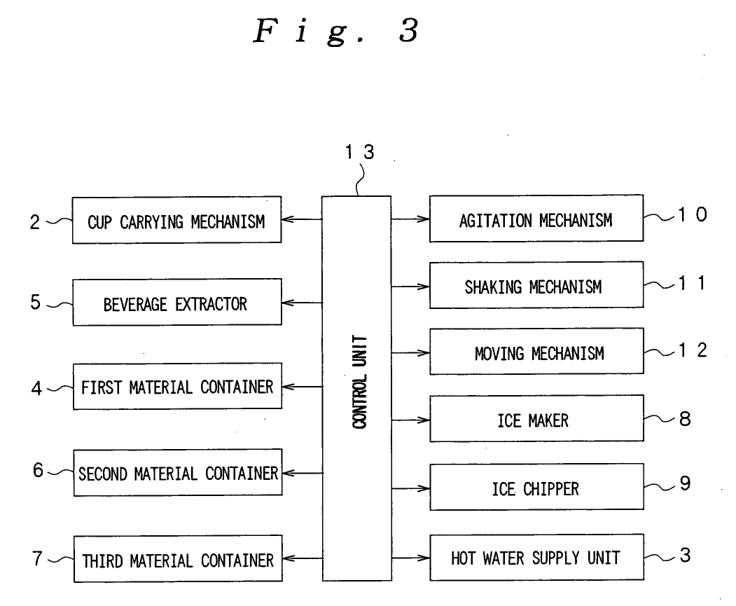

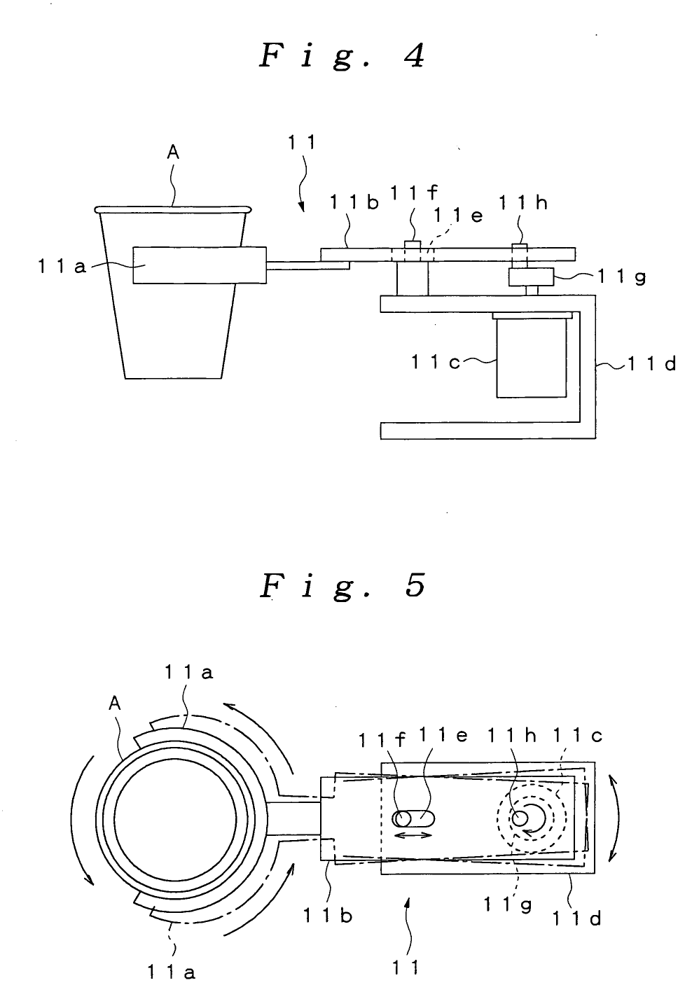

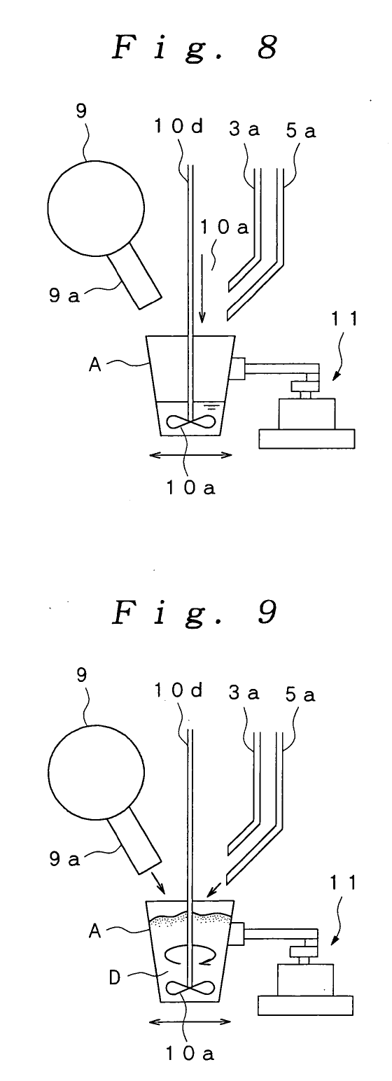

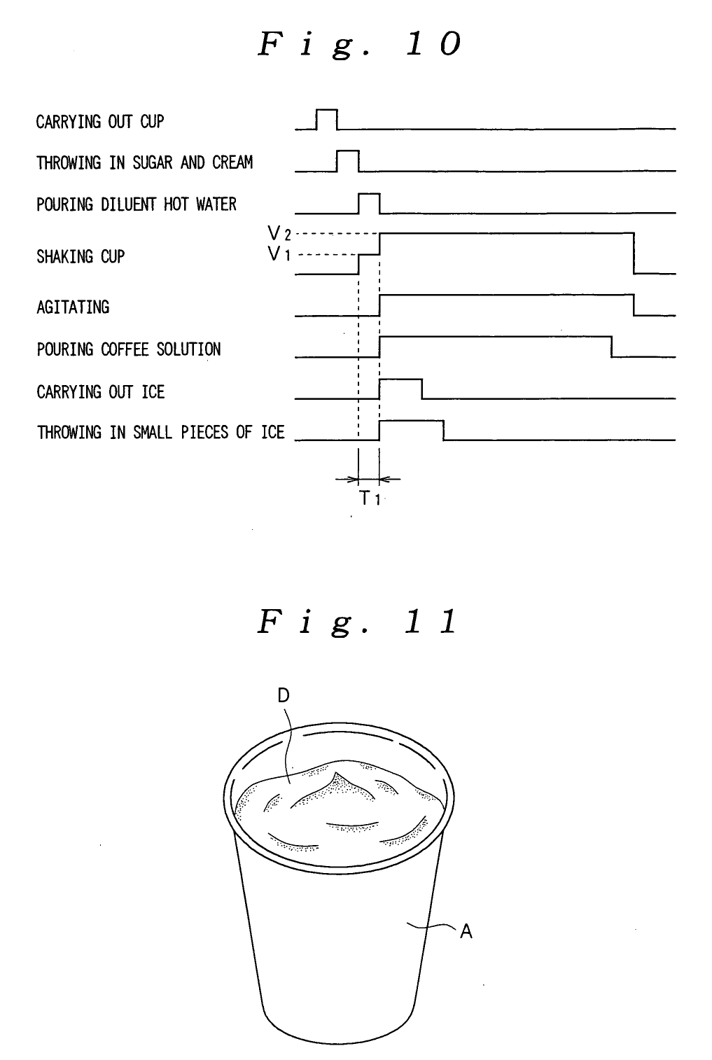

FIGS. 1 through 11 show an embodiment of the present invention. An automatic cup type beverage vending machine shown in FIGS. 1 through 11 is constituted by an automatic vending machine body 1, a cup carrying mechanism 2 for carrying cups A, a hot water supply unit 3 for producing hot water, a first material container 4 for storing coffee beans as a raw material, a beverage extractor 5 for extracting a coffee solution as a beverage material, a second material container 6 for storing sugar as a beverage material, a third material container 7 for storing cream as a beverage material, an ice maker 8 for making solid blocks of ice, an ice chipper 9 for forming small pieces of ice by chipping the ice made by ice maker 8, an agitation mechanism 10 for agitating a beverage, a shaking mechanism 11 for shaking each cup A, a moving mechanism 12 for moving the shaking mechanism 11 in the widthwise direction of the automatic vending machine body 1, and a control unit 13 for controlling beverage preparation operations.

The automatic vending machine body 1 is formed so as to be openable and closable at the front side. In the front face of the automatic vending machine body 1 are provided a plurality of article samples 1a representing various coffee beverages, a plurality of article selection switches 1b corresponding to the article samples 1a, auxiliary selection switches 1c for selection, for example, from “sugared”, “milked” and “black”, a price display window 1d, a coin inlet 1e, a paper money inlet 1f, a coin return outlet 1g and an article outlet 1h. In this embodiment, a semisolid coffee beverage prepared by mixing a coffee solution and small pieces of ice (hereinafter referred to as “frappe beverage”), as well as hot coffee and ice coffee for example, can be selected by the article selection switch 1b.

The cup carrying mechanism 2 is of a well-known construction capable of accommodating cups A, and downwardly carries out cups A one by one.

The hot water supply unit 3 produces hot water at a temperature of about 90° C. by a heater (not shown), and pours a predetermined amount of hot water from a nozzle 3a into one cup A.

The first material container 4 has a mill for milling coffee beans, and carries out to the beverage extractor 5 a predetermined amount of the material (milled beans) measured with a measuring device.

The beverage extractor 5 is of a well-known construction for extracting a coffee solution from the material (milled beans) by using hot water supplied from the hot water supply unit 3. The coffee solution is poured from a nozzle 5a into one cup A.

The second material container 6 contains powder sugar and throws a predetermined amount of sugar into one cup A through a shooter 6a.

The third material container 7 contains powder milk and throws a predetermined amount of milk into one cup A through a shooter 7a.

The ice maker 8 is of a well-known construction for making ice blocks of a predetermined size, and carries out a predetermined amount of ice blocks to the ice chipper 9.

The ice chipper 9 is of a well-known construction for chipping ice blocks into small pieces by using a cutting blade, and throws chipped small pieces of ice into one cup A through a shooter 9a.

The agitation mechanism 10 is constituted by an agitating member 10a in the form of a screw for agitating a beverage, a motor 10b for rotating the agitating member 10a, and a lift mechanism 10c for moving the agitating member 10a along a vertical direction. The agitating member 10a is attached to the lower end of a rotary shaft 10d which extends vertically. The upper end of the rotary shaft 10d is connected to the motor 10b. The lift mechanism 10c is constructed so as to vertically movable along a guide shaft 10e, and is vertically moved together with the motor 10b and the agitating member 10a by a drive mechanism (not shown).

The shaking mechanism 11 is constituted by a cup holder 11a for holding one cup A, a shaking plate 11b connected at one end to the cup holder 11a, a motor 11c for shaking the shaking plate 11b, and a base plate 11d on which the motor 11c is fixed. The cup holder 11a is formed of an annular member having a cutout at a position in the circumferential direction, and supports the peripheral surface of one cup A. The shaking plate 11b has an elongated hole 11e generally at a center in the longitudinal direction and is supported on the upper surface of the base plate 11d by a supporting pin 11f inserted in the elongated hole 11e. A rotating plate 11g is attached to the rotating shaft of the motor 11c. The rotating plate 11g is connected to the shaking plate 11b at the other end by an eccentric pin 11h eccentric from the rotating shaft of the motor 11c. That is, when the motor 11c is rotated in this shaking mechanism 11, the shaking plate 11b turns while being reciprocated on the supporting pin 11f by the eccentric rotation of the eccentric pin 11h, the supporting pin 11f moving along the elongated hole 11e. Circular motion of the cup A held by the cup holder 11a is thereby produced, as indicated by solid line in FIG. 5, thus shaking the cup A.

The moving mechanism 12 is constituted by an endless belt 12a extending in the widthwise direction of the automatic vending machine body 1, and a pair of pulleys 12b disposed at two positions in the widthwise direction to rotatably support the belt 12a. The shaking mechanism 11 is fixed on the upper surface of the belt 12a. That is, in this moving mechanism 12, one of the pulleys 12b is rotated by a motor (not shown) to move one cup A in the widthwise direction of the automatic vending machine body 1 together with the shaking mechanism 11. The moving mechanism 12 moves one cup A to any of a cup carrying out position at the cup carrying mechanism 2, a material discharge position at the second material container 6, a material discharge position at the third material container 7 and a beverage preparation position. At the beverage preparation position, the nozzle 3a of the hot water supply unit 3, the nozzle 5a of the beverage extractor 5, the shooter 9a of the ice chipper 9 and the agitating member 10a of the agitation mechanism 10 are placed.

The control unit 13 is constituted by a microcomputer and is connected to the cup carrying mechanism 2, the hot water supply unit 3, the first material container 4, the beverage extractor 5, the second material container 6, the third material container 7, the ice maker 8, the ice chipper 9, the agitation mechanism 10, the shaking mechanism 11 and the moving mechanism 12.

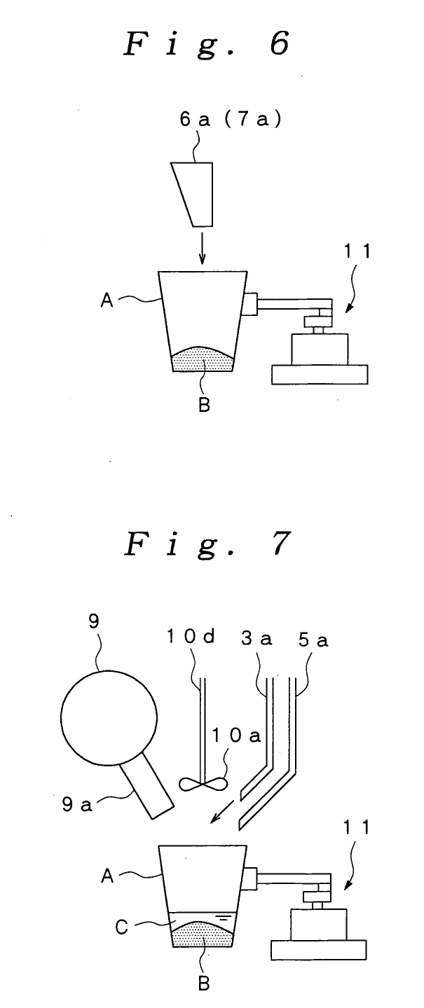

The operation of the control unit 13 will now be described with reference to the time chart of FIG. 10. When a frappe beverage is selected by the article selection switch 1b, one cup A is carried out of the cup carrying mechanism 2 to the cup holder 11a at the cup carrying out position, and the cup A is moved successively to the material discharge position at the second material container 6 and the material discharge position at the third material container 7. Powder material B (sugar and cream) is thrown into the cup A from each of the second and third material containers 6 and 7, as shown in FIG. 6. Subsequently, the cup A is moved to the beverage preparation position by the moving mechanism 12, and diluent hot water C is poured into the cup A from the nozzle 3a of the hot water supply unit 3, as shown in FIG. 7. The agitating member 10a of the agitation mechanism 10 is then moved downward into the cup A and shaking of the cup A is started by the shaking mechanism 11 as shown in FIG. 8. At this time, the cup A is shaken at a predetermined first speed V1 by the shaking mechanism 11. After the passage of T1 from the start of shaking, the cup A is shaken at a second speed V2 higher than the first speed V1 by the shaking mechanism 11 and agitation of the materials is started by rotating the agitating member 10a of the agitation mechanism 10. Simultaneously, a coffee solution is poured into the cup A from the nozzle 5a of the beverage extractor 5. Also, a predetermined amount of ice blocks is carried out from the ice maker 8 to the ice chipper 9 and small pieces of ice are thrown into the cup A from the ice chipper 9. Even after the completion of throwing-in of small pieces of ice, shaking of the cup A and the agitation of the materials are continued while the coffee solution is being poured into the cup A. After the completion of pouring of the coffee solution, shaking of the cup A and agitation of the materials are terminated, thereby completing frappe beverage D.

Thus, in this embodiment, the liquid material and small pieces of ice in the cup A are agitated by the agitation mechanism 10 and the cup A is simultaneously shaken by the shaking mechanism 11. Mixing is performed not only by agitation of the liquid material and small pieces of ice but also by shaking of the cup A. Therefore, the liquid material and small pieces of ice can be mixed uniformly and finely with each other through the entire beverage and any parts of them are not left in an insufficiently mixed state. Thus, a frappe beverage can be prepared which is not inferior in terms of touch to the tongue and palate and appearance to that prepared by mixing a liquid material and crushed ice while crushing ice by a mixer as in a beverage store.

In this case, because a liquid material prepared by diluting sugar and cream provided as powder materials with diluent hot water is used as part of the liquid material, a frappe beverage using powder materials can also be prepared and various materials can be used for preparation of a beverage.

Further, since a liquid material formed of a coffee solution and a liquid material prepared by diluting sugar and cream with diluent hot water is used, a frappe beverage of a coffee taste differing from ordinary hot coffee or ice coffee in terms of touch to the tongue and palate can be prepared and can be sold by this kind of automatic vending machine. Powder materials such as sugar and cream may be diluted with water.

The shaking plate 11b connected at one end to the cup holder 11a is supported by the supporting pin 11f so as to be able to shake, and is shaken about the supporting pin 11f by the eccentric rotation of the rotating plate 11g connected to the shaking plate 11b at the other end, thus enabling the rotation of the motor 11c to be reliably converted into shaking motion by the simple mechanism. Therefore, this arrangement is highly advantageous in being put to practical use. Since the shaking plate 11b is caused to turn while being reciprocated in a direction along the elongated hole 11e by inserting the supporting pin 11f into the elongated hole 11e of the shaking plate 11b, the cup A can be shaken by circular motion of the cup holder 11a and mixing by shaking can be performed more effectively.

Agitation of materials and small pieces of ice is started after the passage of a predetermined time T1 from a state of shaking of the cup A. Therefore, the powder materials (sugar and cream) can be sufficiently dissolved in diluent hot water by only shaking the cup A before agitation is started, and failure to sufficiently mix the materials with small pieces of ice in a case where the materials left in powder form are mixed with ice can be avoided with reliability. In this case, since shaking of the cup and agitation are simultaneously performed after the start of agitation, the agitation power can be increased in comparison with the case of performing agitation only to enable a frappe beverage to be prepared in a short time.

The cup A is shaken at the first speed V1 from the start of shaking of the cup A to the start of agitation, and is shaken at the second speed V2 higher than the first speed V1 after the start of agitation. Low-speed shaking ensures prevention of scattering of the liquid material when the powder materials are dissolved in diluent hot water by only shaking the cup A, and high-speed shaking enables the liquid material and small pieces of ice to be rapidly mixed with each other after throwing in of the small pieces of ice and the start of agitation.

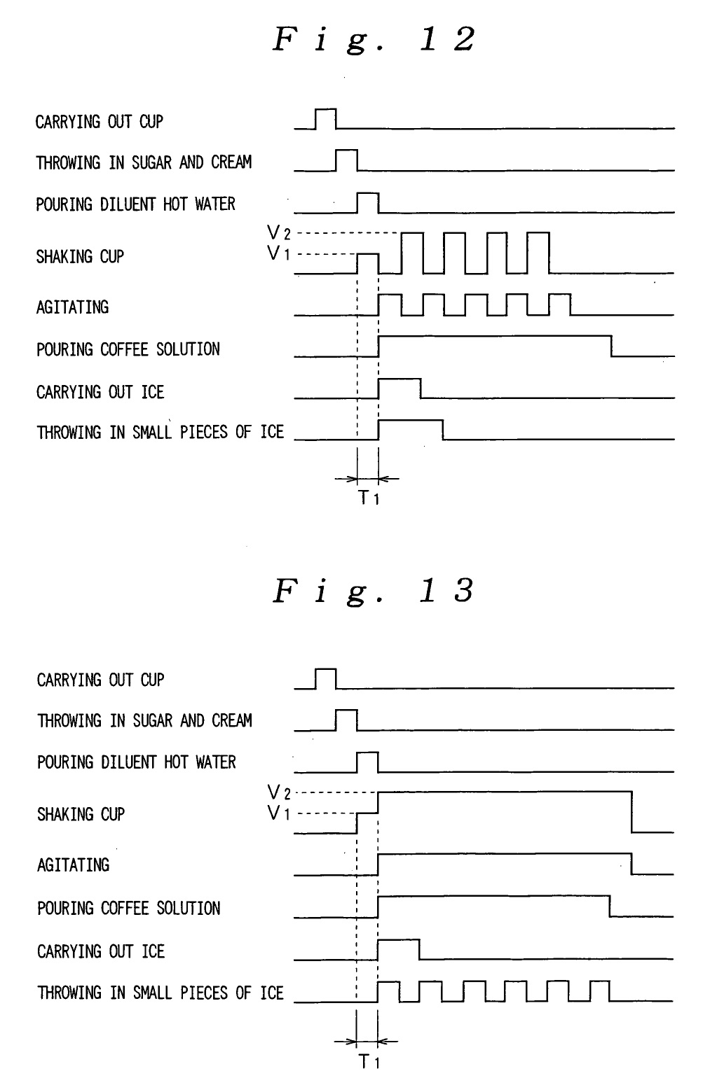

This embodiment has been described with respect to the method of simultaneously performing shaking of the cup A and agitation after staring agitation. However, shaking of the cup A and agitation may be alternately performed, as shown in FIG. 12. A turbulence is thereby caused in the cup A to increase the agitation power.

Small pieces of ice are intermittently supplied into the cup A while shaking of the cup A and agitation are being performed, as shown in FIG. 13. Small pieces of ice are thereby mixed efficiently with the liquid material. This method is effective in reducing the occurrence of failure to sufficiently mix the materials.

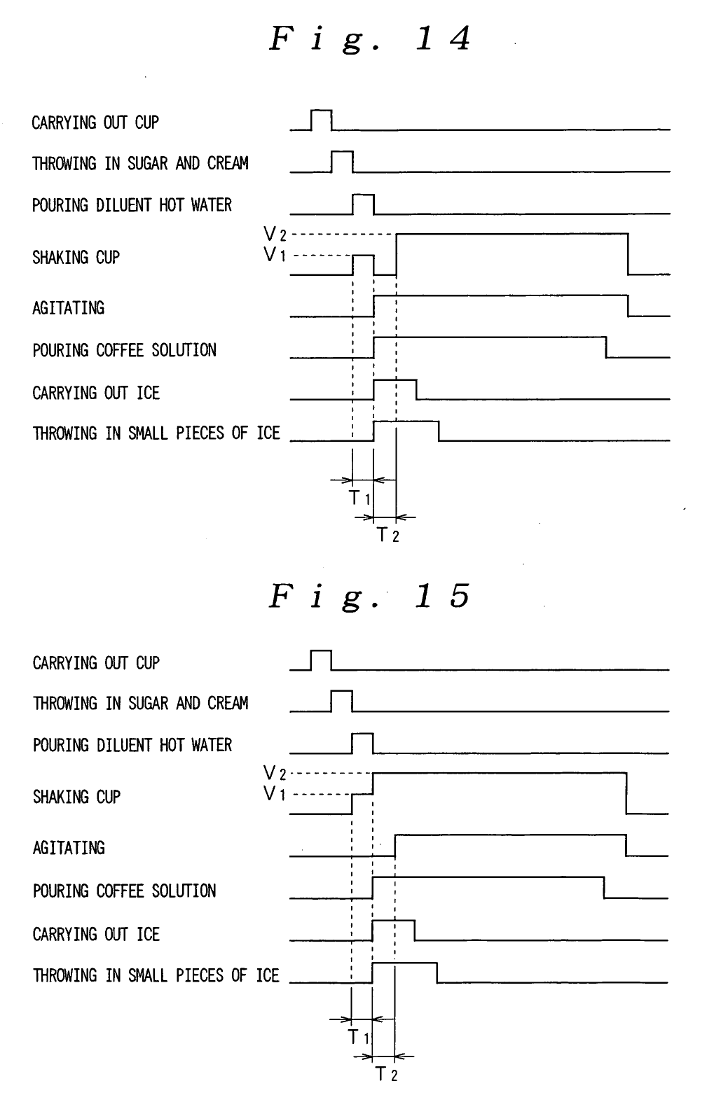

Agitation may be started after the completion of shaking of the cup A, as shown in FIG. 14. Spilling of the beverage out of the cup A can be prevented in this way. This method has the advantage of maintaining the desired appearance.

A process may be performed in which, as shown in FIG. 15, the cup A is shaken during the passage of a predetermined first time period T1; shaking of the cup A is stopped after the passage of the first time period T1; agitation is then started; and shaking of the cup A is started after the passage of a predetermined second time period T2. In this case, no load due to agitation is applied to the shaking mechanism 11 when shaking is started. This method is advantageous in improving the life of the shaking mechanism 11.

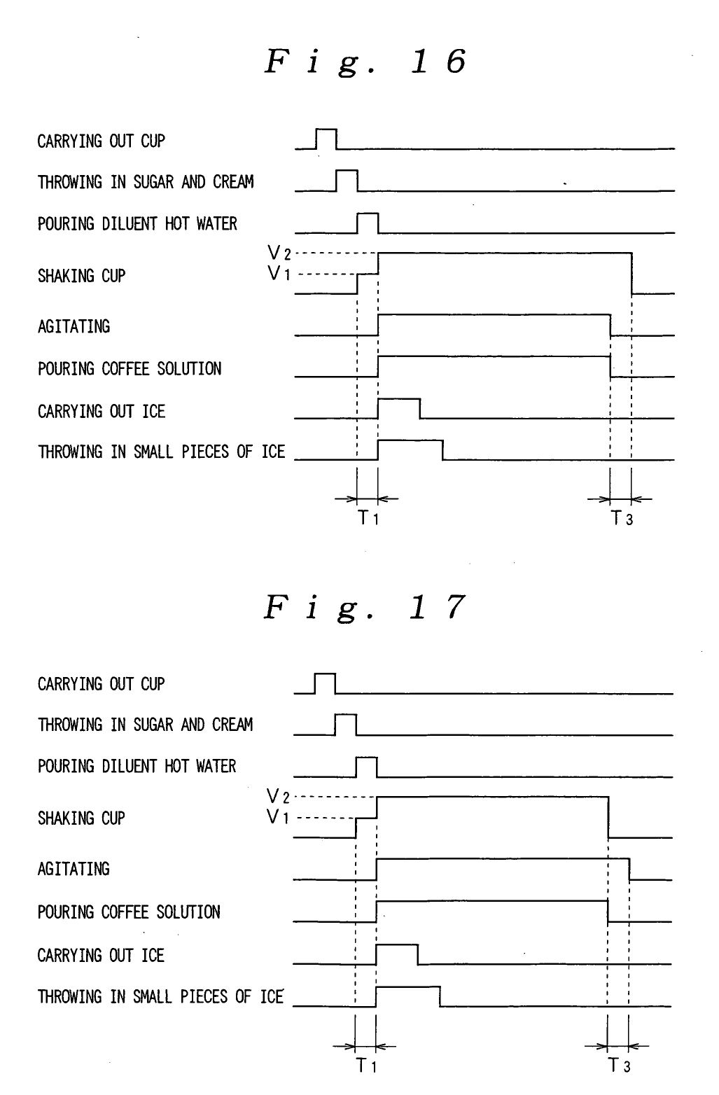

A process may performed in which, as shown in FIG. 16, the cup A is shaken at the first speed V1 during the passage of the first time period T1; the cup A is shaken at the second speed V2 after the passage of the first time period T1; and agitation is started after the passage of the second time period T2 from the start of shaking at the second speed V2. In this case, a load when the shaking speed is changed is not applied to the agitation mechanism 10 when agitation is started. This method is advantageous in improving the durability of the agitation mechanism 10.

Shaking of the cup A may be terminated after the passage of a predetermined time T3 from the termination of agitation, as shown in FIG. 17. In this way, differences in level in the surface of the completed frappe beverage can be reduced to improve the appearance.

Agitation may be terminated after the passage of the predetermined time T3 from the termination of shaking of the cup A, as shown in FIG. 18. In this way, spilling of the beverage from the cup A can be prevented with reliability even in a case where the frappe beverage is soft (the proportion of the liquid material is large relative to that of small pieces of ice). Moreover, the grain size of ice can reduced by continuing agitation after termination of shaking to enable the liquid material and small pieces of ice to be mixed more finely.

While the embodiment has been described with respect to the case of preparing a frappe beverage of a coffee taste, a frappe beverage of a fruit taste, for example, can also be prepared by mixing a fruit-based liquid material and small pieces of ice.

1. An automatic cup type beverage vending machine in which a liquid material and small pieces of ice are agitated in a cup for containing a beverage to prepare a beverage in which the liquid material and small pieces of ice are mixed with each other, the vending machine comprising:
means for supplying a liquid material or a powder material for forming a liquid material into the cup;
means for supplying small pieces of ice into the cup;
means for agitating the liquid material and small pieces of ice in the cup; and
means for shaking the cup in a predetermined direction at the time of preparation of the beverage.

2. The automatic cup type beverage vending machine according to claim 1, wherein said means for shaking comprises by a cup holder which holds the cup, a shaking member connected at its one end to a cup holder, a supporting member which supports the shaking member so that the shaking member is adapted to shake, a rotary member connected to the shaking member at the other end, and a motor which eccentrically rotates the rotary member.

3. The automatic cup type beverage vending machine according to claim 1, further comprising control means for starting agitation after the passage of a predetermined time period from a start of shaking of the cup.

4. The automatic cup type beverage vending machine according to claim 1, further comprising control means for shaking the cup at a predetermined first speed during the passage of a predetermined time period and shaking the cup at a predetermined second speed after the passage of the predetermined time period.

5. The automatic cup type beverage vending machine according to claim 1, further comprising control means for performing shaking of the cup and agitation alternately and intermittently.

6. The automatic cup type beverage vending machine according to claim 1, further comprising control means for intermittently supplying small pieces of ice into the cup while performing at least one of shaking of the cup and agitation.

7. The automatic cup type beverage vending machine according to claim 1, further comprising control means for starting agitation after termination of shaking of the cup.

8. The automatic cup type beverage vending machine according to claim 1, further comprising control means for shaking the cup during the passage of a predetermined first time period, stopping shaking the cup and starting agitation after the passage of the first time period, and starting shaking the cup after the passage of a predetermined second time period from the start of agitation.

9. The automatic cup type beverage vending machine according to claim 1, further comprising control means for shaking the cup at a predetermined first speed during the passage of a predetermined first time period, shaking the cup at a predetermined second speed after the passage of the first time period, and starting agitation after the passage of a predetermined second time period from the start of shaking at the second speed.

10. The automatic cup type beverage vending machine according to claim 1, further comprising control means for terminating agitation after the passage of a predetermined time period from the termination of shaking of the cup.

11. The automatic cup type beverage vending machine according to claim 1, further comprising control means for terminating shaking of the cup after the passage of a predetermined time period from the termination of agitation.

12. The automatic cup type beverage vending machine according to claim 1, wherein at least part of the liquid material is a liquid material prepared by diluting a powder material with water or diluent hot water.

13. The automatic cup type beverage vending machine according to claim 1, wherein a liquid material prepared by diluting sugar and cream with water or diluent hot water and a liquid material formed of a coffee solution are used as said liquid material.
